(19) United States
(12) Patent Application Publication
(10) Pub. No.: US 2024/0097504 A1
(43) Pub. Date: Mar. 21, 2024

(54) NONCONTACT POWER SUPPLY APPARATUS

(71) Applicant: TOYOTA JIDOSHA KABUSHIKI KAISHA, Toyota-shi Aichi-ken (JP)

(72) Inventors: Osamu Yamashita, Toyota-shi Aichi-ken (JP); Naoki Iwata, Kasugai-shi Aichi-ken (JP); Shinjiro Saigusa, Toyota-shi Aichi-ken (JP); Sungmin Cho, Susono-shi Shizuoka-ken (JP); Katsuya Kobayashi, Okazaki-shi Aichi-ken (JP); Toshiya Hashimoto, Miyoshi-shi Aichi-ken (JP)

(73) Assignee: TOYOTA JIDOSHA KABUSHIKI KAISHA, Toyota-shi Aichi-ken (JP)

(21) Appl. No.: 18/242,567

(22) Filed: Sep. 6, 2023

(30) Foreign Application Priority Data
Sep. 15, 2022 (JP) 2022-146967

(51) Int. Cl. H02J 50/70; H02J 50/10; H02J 50/40

(52) U.S. Cl. CPC H02J 50/70; H02J 50/10; H02J 50/402

(57) ABSTRACT

A noncontact power supply apparatus includes a coil unit having a coil for transmitting electric power to a power supply target by noncontact and an electromagnetic shield for reducing a leakage magnetic field of the coil. The electromagnetic shield is the laminate body in which the metal plates are laminated. A lubricant having a predetermined viscosity is applied to a contacting surface between the metal plates.

### CROSS-REFERENCE TO RELATED APPLICATION

This application claims priority to Japanese Patent Application No. 2022-146967 fi led on Sep. 15, 2022, the entire contents of which are herein incorporated by reference.

### FIELD

The present disclosure relates to a noncontact power supply apparatus.

### BACKGROUND

JP2002-331609A discloses a multi-layered magnetic shielding material in which a resin film functioning as adhesives and a nanocrystalline alloy are alternately laminated.

### SUMMARY

In the case of a power supply mat being constructed by connecting transportable power transmission coil units to each other, and installed in a place where it is not normally possible to perform non-contact power supply, such as an event hall or an evacuation center, and non-contact power supply is performed at that place, in order to increase the degree of freedom of installation of the power supply mat (i.e., in order to be able to install the power supply mat on a non-flat road surface, a wall surface, or the like), the power supply mat is required to have a certain degree of flexibility so that the power supply mat can be deflected.

On the other hand, at the time of power supply, it is also necessary to reduce the leakage magnetic field to the back side of the power supply mat. However, if a thick metal plate is disposed on the back side of the power supply mat for this reason, the power supply mat cannot be deflected, and therefore the degree of freedom in installing the power supply mat is reduced.

When laminated by bonding thin metal plates, although it is possible to obtain the required effect of reducing the leakage magnetic field by securing the thickness of the laminate of the metal plate, the rigidity of the laminate becomes high by bonding the metal plates, with the result that the flexibility is lowered.

The present disclosure was made focusing on such problems and has as its object to ensure flexibility of a noncontact power supply apparatus while reducing a leakage magnetic field from the noncontact power supply apparatus.

In order to solve the above problem, a noncontact power supply apparatus according to an aspect of the present disclosure comprises a coil unit configured to have a coil for transmitting electric power to a power supply target by noncontact and an electromagnetic shield configured to reduce a leakage magnetic field of the coil. The electromagnetic shield is a laminate in which metal plates are laminated. A lubricant having a predetermined viscosity is applied to a contacting surface between the metal plates.

According to this aspect of the present disclosure, the electromagnetic shield is a laminate consisting of the metal plates, with the result that it is possible to obtain the effect of reducing the leakage magnetic field corresponding to the thickness of the electromagnetic shield. Then, since the friction coefficient of the contact surface between the metal plates is within a predetermined range by applying a lubricant having a predetermined viscosity to the contact surface between the metal plates, the metal plates can easily slide against each other and the electromagnetic shield can have the desired flexibility.

### BRIEF DESCRIPTION OF DRAWINGS

FIG. 1 is a view of a state in which a power supply mat is formed by connecting a plurality of power transmission coil units.

FIG. 2 is a schematic plan view of a power supply mat comprising four transmission coil units, according to an embodiment of the present disclosure.

FIG. 3 is a schematic cross-sectional view of the power supply mat along III-III line of FIG. 2.

FIG. 4 is a schematic cross-sectional view of the power transmission coil unit along IV-IV line of FIG. 3.

FIG. 5 is an enlarged cross-sectional view of an electromagnetic shield.

### DESCRIPTION OF EMBODIMENTS

Below, referring to the drawings, embodiments will be explained in detail. Note that in the following explanation, similar component elements will be assigned the same reference notations.

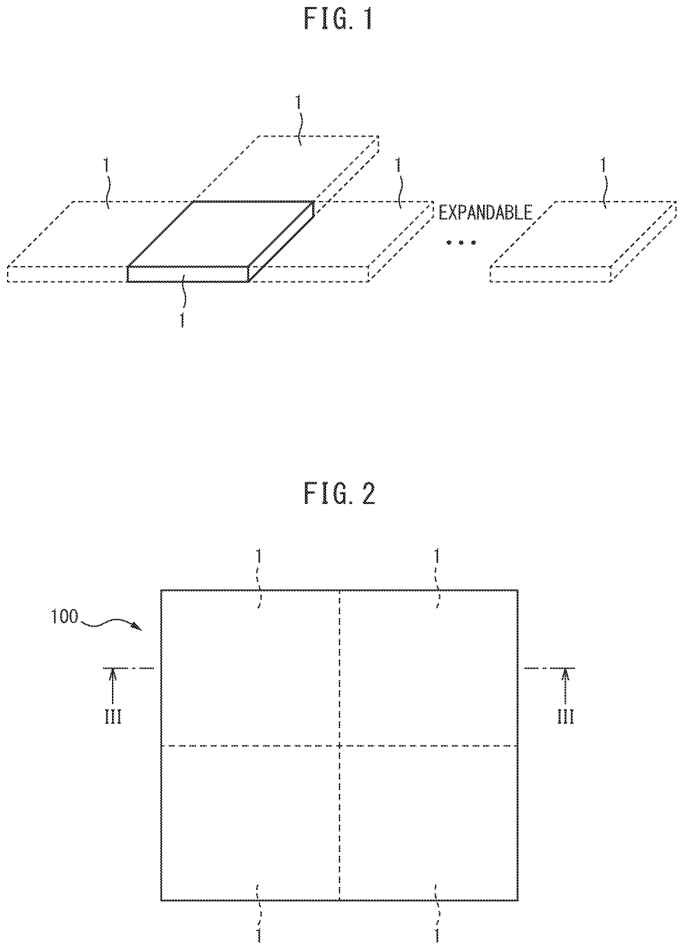

FIG. 1 is a view of a state in which a power supply mat is formed by connecting a plurality of power transmission coil units 1.

As shown in FIG. 1, the power supply mat is formed by physically and electrically connecting transportable power transmission coil units 1, and is installed in a place such as an event hall or an evacuation center where it is not normally possible to perform noncontact power supply, and performs noncontact power supply to a power supply target used in the place. The power supply target is not particularly limited in type, and may be a moving object such as a vehicle or a drone, or may be a communication device, a household electric appliance, or the like. The power transmission coil unit 1 includes a power transmission coil (not shown), and is configured to be able to transmit power supplied from a power source such as an external AC power source to a power supply target by noncontact. The detailed configuration of the power transmission coil unit 1 will be described later with reference to FIG. 2 to FIG. 4.

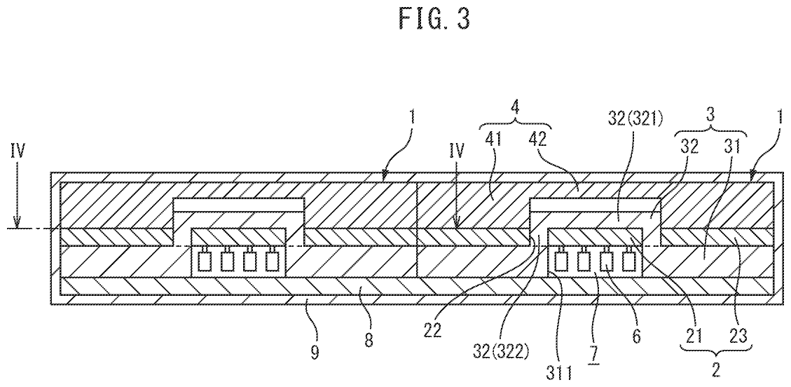

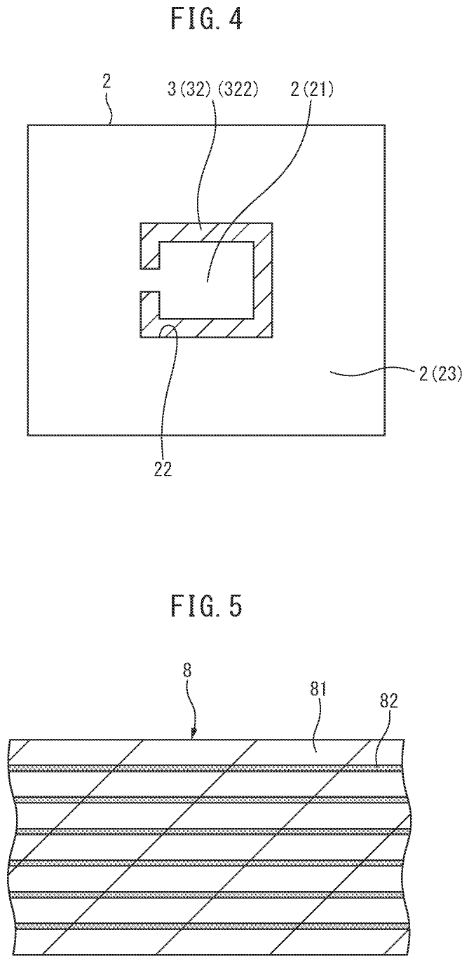

FIG. 2 is a schematic plan view of a power supply mat 100 comprising four power transmission coil units 1, according to an embodiment of the present disclosure. FIG. 3 is a schematic cross-sectional view of the power supply mat 100 along III-III line of FIG. 2. FIG. 4 is a schematic cross-sectional view of the power transmission coil unit 1 along IV-IV line of FIG. 3.

As shown in FIG. 2 and FIG. 3, the power supply mat 100 according to the present embodiment includes four power transmission coil units 1, one electromagnetic shield 8 on which the four power transmission coil units 1 are placed, and a housing member 9 for accommodating them therein.

The power transmission coil unit 1 has a thin flat shape so that a vehicle can easily ride over it, and includes, for example, a printed coil board 2, a core 3, and a spacer 4 as shown in FIG. 3 and FIG. 4. Note that the configuration of the power transmission coil unit 1 described below is merely an example, and the configuration is not particularly limited, as long as it is configured so that power supplied from a power source can be transmitted to a power supply target by noncontact.

The printed coil board 2 is, for example, a hard printed circuit board in which a power transmission coil (not shown) made of a conductor pattern is formed on a surface thereof or the like. An electronic component such as capacitors 6 is attached to the rear surface side of the central portion of the printed coil board 2 by soldering or the like. The power transmission coil formed on the printed coil board 2 forms a resonance circuit together with the capacitors 6 and the like attached to the printed coil board 2, and performs noncontact power transmission by magnetic field resonance coupling (magnetic field resonance) to the power supply target disposed on the power transmission coil unit 1.

As shown in FIG. 4, a region of a central portion of the printed coil board 2, in which an electronic component such as a capacitor 6 is attached to the back surface side, is referred to as a “component attachment portion 21”. In the printed coil board 2, a C-shaped groove-shaped core fitting hole 22 for fitting (or inserting) a protruding portion 322 of a upper core 32 of the core 3 to be described later is formed so as to surround the component attachment portion 21. A circular or rectangular power transmission coil made of a conductor pattern is formed in the outer region (coil formation section 23) of the core fitting hole 22, surrounding the same.

The core 3 includes a lower core 31 and the upper core 32 which are made of a magnetic material such as ferrite.

The lower core 31 is a flat plate-like body having a hole 311 formed in a central portion thereof, and is disposed on the back surface side of the printed coil board 2. The hole 311 of the lower core 31 functions as a component accommodation space 7 in which electronic components such as the capacitors 6 attached to the printed coil board 2 are accommodated when the electromagnetic shield is disposed on the rear surface of the lower core 31.

The upper core 32 includes a flat plate-shaped top portion 321 that covers the surface of the component mounting portion 21 of the printed coil board 2, and a protruding portion 322 that protrudes downward from the top portion 321 and is fitted into the core fitting hole 22 of the printed coil board 2. In the present embodiment, the rear surface of the top portion 321 of the upper core 32 is in contact with the component attachment portion 21 of the printed coil board 2.

The spacer 4 is a resin member for protecting the printed coil board 2 and the core 3 from the load applied to the power transmission coil unit 1 while making the surface of the power transmission coil unit 1 planar. The spacer 4 according to the present embodiment includes a thick portion 41 that is disposed in the coil forming portion 23 and adhered to the surface thereof, and a thin portion 42 that is positioned at a position facing the component attaching portion 21 of the printed coil board 2 when the thick portion 41 is disposed in the coil forming portion 23.

The electromagnetic shield 8 is a flat plate-like body made of a highly conductive metal material (for example, aluminum or copper), and reduces or minimizes the magnetic field leakage to the back side of the power supply mat 100 by canceling the magnetic field lines through the action of eddy currents.

Here, since it is assumed that the power supply mat 100 is used in various places, it is necessary to increase the installation degree of freedom. In order to increase the degree of freedom of installation of the power supply mat 100 (that is, in order to be able to install the power supply mat 100 on a non-flat road surface, a wall surface, or the like), the power supply mat 100 is required to have a certain degree of flexibility so that it can be deflected.

On the other hand, at the time of power supply, it is also necessary to reduce or minimize the leakage magnetic field to the back side of the power supply mat 100. In order to do so, for example, an electromagnetic shield made of one thick metal plate, or an electromagnetic shield made of a laminate in which the metal plates are laminated and bonded to each other is disposed on the back side of the power supply mat 100, the power supply mat 100 cannot be bent, with the result that the degree of freedom in installing the power supply mat 100 is lowered.

Therefore, in the present embodiment, as shown in an enlarged cross-sectional view of the electromagnetic shield 8 in FIG. 5, the electromagnetic shield 8 is a laminated body. Specifically, the electromagnetic shield 8 is a laminate body in which a lubricant 82 having a predetermined viscosity such as grease or an oil compound is applied between the laminated metal plates 81.

The flexibility of the electromagnetic shield 8 configured as described above depends on the coefficient of friction between the metal plates 81, and as the coefficient of friction increases, the metal plates 81 do not slip and thus tend to deteriorate. Therefore, in the present embodiment, the viscosity of the lubricant 82 is set so that the coefficient of friction between the metal plates 81 falls within a predetermined range.

Specifically, the viscosity of the lubricant 82 is set to be equal to or higher than the viscosity in which the lubricating state between the metal plates 81 is a fluid lubricating state (a state in which between the metal plates 81 are completely separated from each other by the lubricant 82) in consideration of the maximum load applied to the power supply mat 100 and the like. That is, the lower limit value of the viscosity of the lubricant 82, when the maximum load is assumed to be applied to the feeding mat 100, the lubricating state between the metal sheet 81 is set to a viscosity near the point of switching from the mixture lubricating state (a state in which between the metal plates 81 are mixed with areas where they are completely separated from each other by lubricant 82 and areas where they are not separated from each other) to the fluid lubricating state. When the viscosity is less than this, the lubricant state between the metal plates 81 is directed toward the boundary lubricating state (a state in which between the metal plates 81 are in direct contact with each other in part), and the friction coefficient rapidly increases, with the possibility that the durability of the electromagnetic shield 8 may deteriorate due to rapid wear.

When the lubrication state between the metal plates 81 is the fluid lubrication state, the friction coefficient between the metal plates 81 basically increases as the viscosity of the lubricant 82 increases. Therefore, the upper limit value of the viscosity of the lubricant 82 is set to be equal to or less than the viscosity in which the desired flexibility is obtained in the viscosity region in which the lubricating state between the metal plates 81 becomes the fluid lubricating state.

By laminating a plurality of thin metal plates 81 in this way, it is possible to form an electromagnetic shield 8 made of a metal laminate having a constant thickness, and it is possible to obtain the effect of reducing the leakage magnetic field corresponding to the thickness. Further, since the lubricant 82 having a predetermined viscosity is applied to between the metal plates 81, it is possible to slip the metal plate 81 to some extent by keeping the friction coefficient between the metal plates 81 within a predetermined range, it is possible to impart a desired flexibility to the electromagnetic shield 8.

In the present embodiment, as the lubricant 82, a silicone oil compound having high heat dissipation performance in which an additive having high thermal conductivity is blended is used. Accordingly, heat generated by the power transmission coil can be easily dissipated to the back surface of the power supply mat 100 via the electromagnetic shield 8.

The housing member 9 is, for example, a housing made of cloth or resin having flexibility equal to or higher than that of the electromagnetic shield 8.

The power supply mat 100 (noncontact power supply apparatus) according to the embodiment explained above comprises the power transmission coil unit 1 (coil unit) having the power transmission coil for transmitting electric power to a power supply target by noncontact and the electromagnetic shield 8 for reducing a leakage magnetic field of the power transmission coil. The electromagnetic shield 8 is the laminate body in which the metal plates 81 are laminated, and the lubricant 82 having a predetermined viscosity is applied to a contacting surface between the metal plates 81. Specifically, in the present embodiment, the viscosity of the lubricant 82 is a viscosity in which a friction coefficient of the contacting surface between the metal plates 81 falls within a predetermined range, and the lower limit value of the viscosity of the lubricant 82 is a value in the vicinity of a viscosity in which a lubricating state of the contacting surface between the metal plates 81 is switched from the mixed lubrication state to the fluid lubrication state.

In this way, by forming the electromagnetic shield 8 as a laminated body in which a plurality of metal plates 81 are laminated, it is possible to obtain the effect of reducing the leakage magnetic field corresponding to the thickness of the electromagnetic shield 8. Then, by applying a lubricant 82 having a predetermined viscosity to the contact surface between the metal plates 81, it is possible to keep the friction coefficient between the metal plates 81 within a predetermined range, whereby the metal plates 81 can slide to some extent, it is possible to impart a desired flexibility to the electromagnetic shield 8.

Further, in the present embodiment, the lubricant 82 contains an additive with high thermal conductivity, which makes it easier to dissipate the heat generated by the power transmission coil to the back surface of the power supply mat t 100 through the electromagnetic shield 8.

Above, embodiments of the present disclosure were explained, but the above embodiments only show some of the examples of application of the present disclosure. It is not meant to limit the technical scope of the present disclosure to the specific constitutions of the embodiments.

For example, in the above-described embodiment, it is configured to reduce the leakage magnetic field of the four power transmission coil units 1 by one electromagnetic shield, the electromagnetic shield 8 may be provided for each power transmission coil unit 1. In this case, a power supply mat including one power transmission coil unit 1 and an electromagnetic shield 8 disposed on the back surface of the power transmission coil unit 1 can also be configured.

In the case where the electromagnetic shield 8 is provided for each power transmission coil unit 1, if a gap is formed between the power transmission coil units 1 when the power transmission coil units 1 are connected to each other, there is a possibility that a leakage magnetic field is generated on the back side of the power supply mat 100 from the gap. On the other hand, by configuring so as to reduce the leakage magnetic field of the plurality of power transmission coil units 1 by one electromagnetic shield 8 (that is, by arranging a plurality of connected power transmission coil units 1 on the surface of one electromagnetic shield 8), it is possible to prevent the leakage magnetic field from occurring from the gap between the power transmission coil units 1.

1. A noncontact power supply apparatus comprising:
a coil unit configured to have a coil for transmitting electric power to a power supply target by noncontact; and
an electromagnetic shield configured to reduce a leakage magnetic field of the coil, wherein
the electromagnetic shield is a laminate in which metal plates are laminated, and
a lubricant having a predetermined viscosity is applied to a contacting surface between the metal plates.

2. The noncontact power supply apparatus according to claim 1, wherein
the lubricant is a lubricant containing an additive having high thermal conductivity.

3. The noncontact power supply apparatus according to claim 1, wherein
the viscosity of the lubricant is a viscosity in which a friction coefficient of the contacting surface between the metal plates falls within a predetermined range, and
a lower limit value of the viscosity of the lubricant is a value in the vicinity of a viscosity in which a lubricating state of the contacting surface between the metal plates is switched from a mixed lubrication state to a fluid lubrication state.

4. The noncontact power supply apparatus according to claim 1, wherein
a plurality of coil units connected to each other are arranged on a surface of the electromagnetic shield.
